(19) United States
(12) Patent Application Publication
(10) Pub. No.: US 2020/0188839 A1
(43) Pub. Date: Jun. 18, 2020

(54) HEAT-INTEGRATED TRANSFORMATIVE CARBON DIOXIDE CAPTURE PROCESS

(71) Applicant: University of Kentucky Research Foundation, Lexington, KY (US)

(72) Inventors: Kunlei Liu, Lexington, KY (US); Heather Nikolic, Lexington, KY (US); Fan Zhen, St. Clair, MI (US); Jesse Thompson, Lexington, KY (US); Amanda Warriner, Lexington, KY (US)

(21) Appl. No.: 16/711,633

(22) Filed: Dec. 12, 2019

Related U.S. Application Data
(60) Provisional application No. 62/779,702, filed on Dec. 14, 2018.

(51) Int. Cl. B01D 53/14; B01J 19/32; B01D 53/18

(52) U.S. Cl. CPC B01D 53/1475; B01J 19/32; B01D 2252/20484; B01D 53/1406; B01D 2258/0283; B01D 53/18

(57) ABSTRACT

An apparatus includes an absorber having a first packing section, a second packing section and a third packing section. The first packing segment includes a first structured packing, having a first specific surface area SA1, the second packing segment includes a second structured packing, having a second specific surface area SA2, and the third packing segment includes a third structured packing, having a third specific surface area SA3 where SA1<SA2<SA3. The structured packing in the various packing segment may be periodically interrupted with one or more layers of random packing.

### RELATED APPLICATIONS

This application claims priority to U.S. Provisional Patent Application Ser. No. 62/779,702 filed on Dec. 14, 2018 which is hereby incorporated by reference in its entirety.

### GOVERNMENT SUPPORT

This invention was made with government support under Grant No. DE-FE-0007395 awarded by the Department of Energy. The government has certain rights in the invention.

### TECHNICAL FIELD

This document relates generally to a new and improved apparatus and method for capturing carbon dioxide (CO₂) from an acid gas stream.

### BACKGROUND

The cleaning of acid gases or sour gas, such as carbon dioxide in particular, from natural gas and in oil refining has been an extensively practiced technology. The industrial removal of carbon dioxide from natural gas dates back to the 1930's.

In the 21st century, due to the potential impact of anthropogenic carbon dioxide emissions on the climate, post-combustion carbon dioxide capture has gained tremendous attention. While several technologies exist for the removal of acid gases, one of the most commonly employed practices is the use of aqueous amines.

In this process, an aqueous amine solution is circulated between an absorber/absorption tower and a stripper. The flue gas or acid gas, containing carbon dioxide enters the bottom of the absorber while the aqueous amine absorbent enters the top of the absorber in counter-current flow to the acid gas. As the acid gas and the amine absorbent come into contact in the absorber, the absorbent removes the carbon dioxide from the gas stream. The amine solution, now rich in carbon dioxide, is discharged from the bottom of the absorber and passed through a heat exchanger to improve efficiency before entering the top of the stripper where the amine solution is heated to a higher temperature. The stripper removes the carbon dioxide as a gas from the amine solution. The carbon dioxide is then passed through a condenser and separated from water at a separator. The carbon dioxide is then subjected to downstream processing or storage while the water is returned to the stripper. The carbon dioxide lean amine solution exits the bottom of the stripper and is returned to the absorber by way of the heat exchanger and a chiller.

The treated acid gas or flue gas is discharged from an upper end of the absorber. Significantly, as the acid gas/flue gas is treated in the absorber a temperature bulge typically occurs 10-20% from the top of the uniformly packed column when operated under low liquid/gas ratio. As a consequence, 30-40% of the packing, from beneath the temperature bulge to the intercooling location, is operated near a carbon dioxide mass transfer driving force pinch point, thus rendering this section ineffective.

This document is related to a new and unique apparatus having a discretized packing arrangement, as well as to a related method, that are both adapted to modify this temperature profile, effectively moving the temperature bulge down the absorber thereby resulting in as much as a 5-11% increase in rich loading, depending upon solvent lean loading.

### SUMMARY

In accordance with the purposes and benefits set forth herein, a new and improved apparatus is provided. That apparatus comprises an absorber having a discretized packing arrangement including a first packing _{[LK1]}segment, a second packing segment and a third packing segment wherein the first packing segment includes a first structured packing having a first specific surface area SA1, the second packing segment includes a second structured packing having a second specific surface area SA2 and the third packing segment includes a third structured packing having a third specific surface area SA3 where SA1<SA2<SA3. One or two or more packing makes up a section separated by pre-installed mechanical gas and liquid distributors.

More specifically, the second structured packing segment is provided between the first structured packing segment and the third structured packing segment within the absorber. Still more specifically, the first packing segment is provided above the second packing segment and the second packing segment is provided above the third packing segment. Generally, the first and second packing segments will be combined into one section (the top packing section of absorber), and the third packing segment makes up the bottom section of packing. A set of mechanical gas and liquid distributor is installed between top and bottom packing section.

In one or more of the many possible embodiments of the absorber, at least one liquid/gas distributor is included in at least one of the first packing segment, the second packing segment and the third packing segment. In one or more of the many possible embodiments of the apparatus, the at least one liquid/gas distributor is a section of random packing.

For purposes of this document, the terminology “structured packing” refers to a uniform arrangement of packing material or elements. For purposes of this document, the terminology “random packing” refers to randomly fitting material or elements used to increase the surface area over which reactants can interact while minimizing the complexity of the column. For purposes of this document, the packing “segment” refers a group of packing materials with same specification. For purposes of this document, the packing “section” refers a set of packing materials with one or more packing segments.

Significantly, the random packing used in the absorber is characterized by a random packing unit pressure drop that is greater than any unit pressure drop characteristic of the first structured packing of the first packing segment, the second structured packing of the second packing segment and the third structured packing of the third packing segment.

In one or more of the many possible embodiments of the apparatus, the first specific surface area SA1 of the first structured packing is less than 34 ft²/ft³, the second specific surface area SA2 is between 34 ft²/ft³ and 129 ft²/ft³ and the third specific surface area SA3 is above 152 ft²/ft³.

In one or more of the many possible embodiments of the apparatus, the first packing segment includes multiple layers of the first structured packing separated by a first layer of the random packing. In one or more of the many possible embodiments, the multiple layers of the first structured packing have a first thickness T1 of 121.92-182.88 cm and the layer of random packing has a second thickness T2 of 7.62-15.24 cm.

In one or more of the many possible embodiments of the apparatus, the second packing segment includes multiple layers of the second structured packing having the first thickness T1 separated by a second layer of the random packing having the second thickness T2.

In one or more of the many possible embodiments of the apparatus, the third packing segment includes multiple layers of the third structured packing having the first thickness T1 separated by a third layer of the random packing having the second thickness T2.

In one or more of the many possible embodiments of the apparatus, the absorber is adapted to remove carbon dioxide from a flue gas stream using an amine solvent and the apparatus further includes a stripper adapted to remove carbon dioxide from the amine absorbent.

In one or more of the many possible embodiments of the apparatus, the apparatus may also include a secondary stripper downstream from the stripper. The stripper may include (a) an upper packing section including the third structured packing having the third specific surface area SA3 and (b) a lower packing section including the first and/or second structured packing having the first specific surface area SA1 and the second specific surface area SA2.

In one or more of the many possible embodiments of the apparatus, the upper packing section may include multiple layers of the third structured packing separated by a fourth layer of the random packing.

In one or more of the many possible embodiments of the apparatus, the lower packing section includes multiple layers of the first and/or second structured packing separated by a fifth layer of the random packing.

In one or more of the many possible embodiments of the apparatus, the secondary stripper includes (a) a top packing section including the second structured packing, having the second specific surface area SA2, and (b) a lower packing section including a third structured packing, having a third specific surface area SA3.

In accordance with an additional aspect, a new and improved method of capturing carbon dioxide from an acid gas stream comprises the steps of: (a) providing an absorber tower with a first packing segment, having a first specific surface area SA1, a second packing segment, having a second specific surface area SA2, and a third packing segment, having a third specific surface area SA3, where SA1<SA2<SA3, (b) subjecting the acid gas stream to a countercurrent flow of a carbon dioxide lean amine solvent in the absorber tower, (c) separately discharging treated acid gas and a carbon dioxide rich amine solvent from the absorber tower and (d) recovering the carbon dioxide from the carbon dioxide rich amine solvent in a stripper and returning carbon dioxide lean amine solvent to the absorber tower.

In one or more of the many possible embodiments of the method, the method may include positioning the second packing segment between the first packing segment and the second packing segment. In one or more of the many possible embodiments, the method may include providing at least one a segment of random packing as liquid/gas distributor in at least one of the first packing segment, the second packing segment and the third packing segment.

In the following description, there are shown and described several embodiments of the apparatus and the related method. As it should be realized, the apparatus and method are capable of other, different embodiments and their several details are capable of modification is various, obvious aspects all without departing from the apparatus and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and method and together with the description serve to explain certain principles thereof.

FIG. 1 is a schematic illustration of one possible embodiment of the new and improved apparatus including an absorber, a stripper and a secondary stripper.

FIG. 2 is a detailed schematic view of the absorber illustrating the new and improved discretized packing arrangement that improves the efficiency of the carbon dioxide capture process.

FIG. 3 is a detailed schematic view of the stripper illustrating the new and improved discretized packing arrangement that improves the efficiency of the carbon dioxide stripping process.

FIG. 4 is a detailed schematic view of the secondary stripper illustrating the new and improved discretized packing arrangement that improves the efficiency of the carbon dioxide stripping process.

FIG. 5 is a graph of packing height vs. temperature that illustrates how the discretized packing arrangement described in this document modifies the temperature profile of the absorber column resulting in a 5-11% increase in rich loading, depending upon solvent lean loading.

Reference will now be made in detail to the illustrated embodiments of the apparatus, examples of which are illustrated in the accompanying drawing figures.

### DETAILED DESCRIPTION

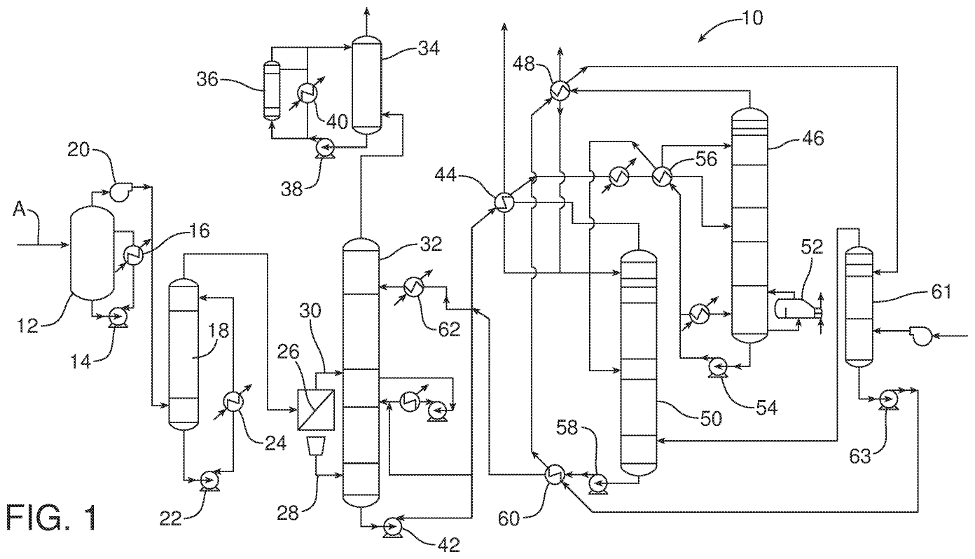

Reference is now made to FIG. 1 generally illustrating at a high level the new and improved apparatus 10. Flue gas from a coal fired power plant (not shown) is delivered to a direct contact cooler 12 (note action arrow A) where the flue gas is contacted with water being circulated by a pump 14. That water is first cooled by heat exchange with a cooling water supply at heat exchanger 16. As a result, the temperature of the flue gas is reduced to 37.78-48.89° C. Further, water vapor is removed from the flue gas. This minimizes the chemicals used in the downstream pretreatment column 18.

Next, a blower 20 delivers the flue gas to the pretreatment column 18 where the flue gas is treated with an aqueous solution of soda ash (Na₂CO₃) or sodium hydroxide (NaOH) to remove sulfur dioxide (SO₂). More particularly, the pump 22 circulates the caustic solution through a second cooling water supply heat exchanger 24 if needed and the pretreatment column 18. The removal of the sulfur dioxide serves to minimize thermal stable salt formation and degradation of the solvent in the CO₂ capture block.

The flue gas is then passed through a membrane 26, of a type known in the art, to split the flue gas into two streams. Such a membrane is more fully described in U.S. Pat. No. 9,409,120 (owned by the assignee of the present invention), the full disclosure of which is incorporated herein by reference.

The first stream 28 is a CO₂-enriched permeate stream comprising approximately 24% of the total flue gas and containing approximately 25% CO₂ after removal of water vapor at 40° C. The second stream 30 is a CO₂-lean reject stream (approximately 76% of the total flue gas flow rate) containing approximately 10% CO₂ after water removal at 40° C.

More particularly, the two streams 28 and 30 are both delivered to the absorber tower or absorber 32. There the flue gas is subjected to a concurrent stream of an CO₂ absorbent or amine solvent of a type known in the art to be suitable for CO₂ capture. Such a CO₂ absorbent includes primary, secondary and tertiary amines including, for example, 1-amino-2-propanol (A2P), 2-amino-2-methyl-1-propanol (AMP), piperidine (PZ), methyldiethanolamine (MDEA) and other compounds, including, for example, anti-oxidant.

Following CO₂ removal, the treated flue gas is delivered from the top of the absorber 32 to the solvent recovery column 34 where CO₂ absorbent entrained in the treated flue gas is recovered using a countercurrent flow of wash water and an amine nucleation agent circulated through a separator element 36, such as a screen or filter, by a pump 38. As shown, the wash water, amine nucleation agent and entrained amine solvent may be cooled by a cooling water supply in the heat exchanger 40. Wash water, including entrained amine solvent separated from the amine nucleation agent by the separator element 36 is returned to the absorber 32 by means of a return circuit not shown.

The solvent recovery column 34 and the method for recovering the amine solvent from the treated flue gas are more fully described in U.S. patent application Ser. No. 16/460,229 entitled APPARATUS AND METHOD FOR RECOVERING AN AMINE SOLVENT FROM AN ACID GAS STREAM and filed on Jul. 2, 2019, the full disclosure of which is incorporated herein by reference. As disclosed therein, the amine nucleation agent may comprise an activated carbon having a density of 997 kg/m³+/−600 kg/m³ and a diameter less than 1.0 millimeter. The treated flue gas may then be discharged.

The now carbon dioxide rich CO₂-absorbent or amine solvent is discharged from the bottom of the absorber 32 and directed by the pump 42 through the heat exchanger 44 to the stripper 46 where carbon dioxide is stripped from the carbon rich CO₂-absorbent or amine solvent. The carbon dioxide exits at the top of the stripper 46 and is routed through a primary heat recovery exchanger 48 before exiting as a CO₂ product stream that may be stored or undergo other chemical processing (not shown). The reboiler 52 functions to recycle carbon dioxide rich CO₂-absorbent or amine solvent through the stripper 46 to ensure more efficient processing.

Carbon dioxide semi-lean CO₂-absorbent or amine solvent exits the bottom of the stripper 46 and is transferred by pump 54 through the heat exchanger 56 to the secondary stripper 50 where even more carbon dioxide is stripped from the carbon dioxide semi-lean CO₂-absorbent or amine solvent. This additional carbon dioxide exits the top of the secondary stripper 50 and is routed through the secondary heat exchanger 44 before being recycled to the power plant boiler. The now carbon dioxide lean CO₂-absorbent or amine solvent exits the bottom of the secondary stripper 50 and is returned by the pump 58 through the lean heat recovery exchanger and the solvent polishing exchanger 62 to the absorber 32 where it is used to capture carbon dioxide from the flue gas as previously described. The water evaporator 61 supplies makeup water to amine loop from energy recovered from the heat exchangers 60 and 48 by operation of the pump 63.

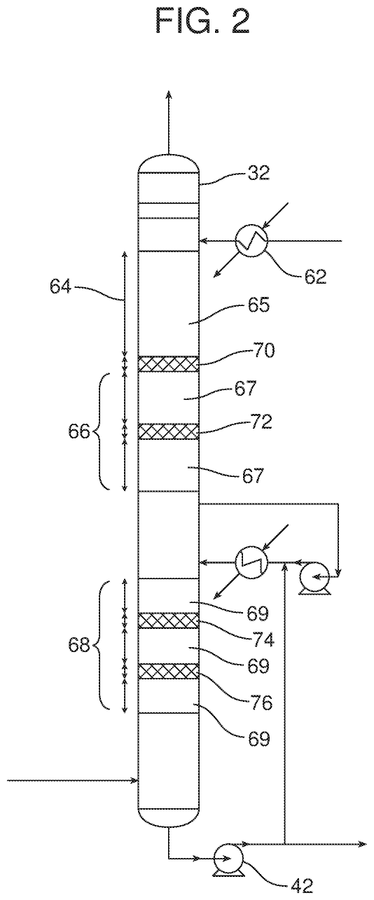

Reference is now made to FIG. 2 which illustrates the absorber 32 in detail. As illustrated, the absorber 32 includes a first or uppermost packing segment 64, a second or intermediate packing segment 66 and a third or lowermost packing segment 68. The first packing segment 64 includes a first structured packing 65 of high capacity and low efficiency having a first specific surface area SA1. The second packing segment 66 includes a second structured packing 67 of high efficiency and high capacity having a second specific surface area SA2. The third packing segment 68 includes a third structured packing 69 of low capacity and high efficiency having a third specific surface area SA3. SA1 is less than SA2 and SA2 is less than SA3.

In one possible embodiment of the apparatus 10, the first structured packing has a first specific surface area SA1 of less than 34 ft²/ft³, the second structured packing has a second specific surface area SA2 of between 34 ft²/ft³ and 129 ft²/ft³ and the third structured packing has a third specific surface area SA3 of above 152 ft²/ft³.

In the illustrated embodiment, a first in-situ “random packing” liquid/gas distributor 70 is provided between the first packing segment 64 and the second packing segment 66. A second in-situ “random packing” liquid/gas distributor 72 is provided at an intermediate point of the second packing segment 66. Two additional in-situ “random packing” liquid/gas distributors 74, 76 are provided at spaced points in the third packing segment 68. Each of the in-situ liquid/gas distributors 70, 72, 74, 76 may comprise a layer of random packing. That random packing is characterized by a first pressure drop per height PD1 that is greater than any pressure drop per height PD2 of the first structured packing 65 in the first packing segment 64, the second structured packing 67 in the second packing segment 66 and the third structured packing 69 in the third segment 68.

In one possible embodiment of the apparatus 10, the first or upper segment 64 comprises the top 20-30% of the total height of the top packing 64, 66 and 68. The second segment 66 comprises the middle 30-50% of the total height of the packing 64, 66 and 68. The third segment 68 comprises the bottom 30-40% of the total height of the packing 64, 66 and 68.

In one possible embodiment of the apparatus 10, every 60.96 to 243.84 cm of structured packing is interrupted by 7.62-15.24 cm of in-situ liquid/gas distributor in the form of random packing. This includes the first structured packing 65 used to form the first packing segment 64, the second structured packing 67 used to form the second packing segment 66 and/or the third structured packing 69 used to form the third packing segment 68.

It has been found that due to the low CO₂ absorption driving force in utility flue gas and the highly viscous nature of second generation advanced amine solvents, the low pressure drop structured packing used in the packing sections 64,66 and 68 suffers from a lack of macro-mixing/turbulence between the bulk solvent and the gas-liquid interface. This results in localized channel flow and significantly reduces column effectiveness. The application of short sections 7.62-15.24 cm of high pressure drop random packing in the form of in-situ liquid/gas distributors 70, 72, 74 and 76 re-adjusts the pressure and redistributes the liquid within the structured packing 65, 67, 69. As a result, the efficiency of the absorber 32 is significantly enhanced.

In one possible embodiment of the absorber 32, the first packing segment 64 includes multiple layers of the first structured packing 65 separated by in-situ gas/liquid distributor of random packing. The multiple layers of the first structured packing 65 may have a first thickness T1 of 121.92-182.88 cm and the layer of random packing may have a second thickness T2 of 7.62-15.24 cm. The second packing segment 66 may include multiple layers of the second structured packing 67 having a first thickness T1 of 121.92-182.88 cm separated by the layer of random packing 72 having a thickness T2 of 7.62-15.24 cm. The third packing segment 68 may have multiple layers of the third structured packing 69 having a thickness T1 of 121.92-182.88 cm separated by the layer of random packing 74 or 76 having a thickness T2 of 7.62-15.24 cm.

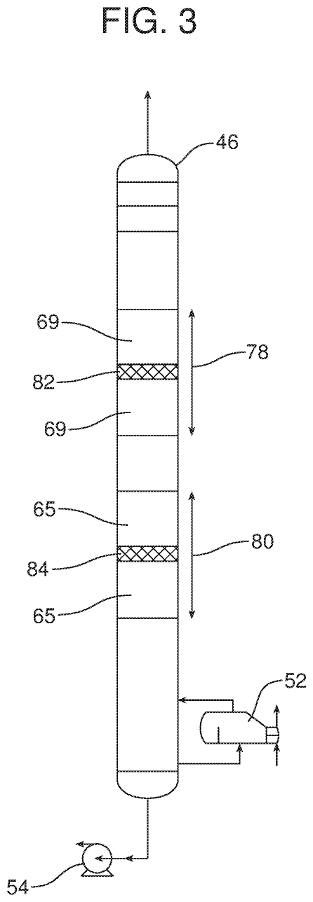

Reference is now made to FIG. 3 which schematically illustrates the stripper 46 in detail. In the illustrated embodiment, the stripper 46 includes an upper packing section 78 and a lower packing section 80. The upper packing section 78 includes the third structured packing 69 having the third specific surface area SA3 while the lower packing section 80 includes the first or the second structured packing 65 having the first specific surface area SA1 and second specific surface area SA2. Both the upper packing section 78 and the lower packing section 80 may include multiple layers of the structured packing 69, 65 separated by in-situ liquid/gas distributors 82, 84 in the form of a layer of random packing of the type previously described. Every 60.96 to 243.84 cm of structured packing 69, 65 may be interrupted by 7.62-15.24 cm of in-situ liquid/gas distributor 82, 84 in the form of random packing. Once again, the alternating layered arrangement of structured packing and random packing re-adjusts the pressure and redistributes the liquid within a section 78, 80 of the structured packing thereby increasing stripper efficiency.

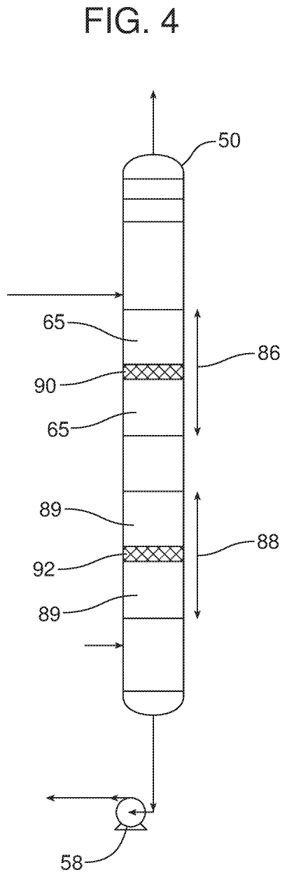

Reference is now made to FIG. 4 which schematically illustrates the secondary stripper 50 in detail. In the illustrated embodiment, the secondary stripper 50 includes a top packing section 86 and a bottom packing section 88. The top packing section 86 includes the first structured packing 65 having the first specific surface area SA1 while the lower packing section 80 includes a fourth structured packing 89 having fourth specific surface area SA4 where SA4=SA2 or SA3. Both the top packing section 86 and the lower packing section 88 may include multiple layers of the structured packing 65, 89 separated by in-situ liquid/gas distributors 90, 92 in the form of a layer of random packing of the type previously described. Every 60.96 to 243.84 cm of structured packing 65, 89 may be interrupted by 7.62-15.24 cm of liquid/gas distributor 90, 92 in the form of random packing. Once again, the alternating layered arrangement of structured packing and random packing re-adjusts the pressure and redistributes the liquid within a section 86, 88 of the structured packing thereby increasing secondary stripper efficiency.

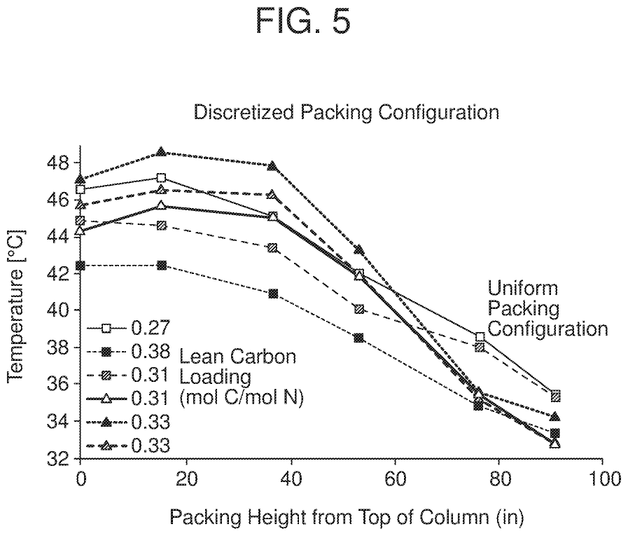

Reference is now made to FIG. 5 which is a graph of packing height versus temperature. This graph illustrates how the discretized packing arrangement, including the alternating layers of structured packing and random packing as described above, modify the temperature profile of the absorber column resulting in a 5-11% increase in CO₂ rich loading, depending upon solvent lean loading.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus, comprising:
an absorber having a first packing segment, a second packing segment and a third packing segment wherein the first packing segment includes a first structured packing having a first specific surface area SA1, the second packing segment includes a second structured packing having a second specific surface area SA2 and the third packing includes a third structured packing having a third specific surface area SA3 where SA1<SA2<SA3.

2. The apparatus of claim 1, wherein the second packing segment is provided between the first packing segment and the third packing segment within the absorber.

3. The apparatus of claim 1, wherein the first structure packing segment is provided above the second structured packing segment within the absorber.

4. The apparatus of claim 3, further including at least one in-situ liquid/gas distributor in at least one packing section of the first packing segment, the second packing segment and the third packing segment.

5. The apparatus of claim 4, wherein the at least one in-situ liquid/gas distributor is a section of random packing.

6. The apparatus of claim 5, wherein the section of random packing is characterized by a random packing pressure drop per height greater than any pressure drop per height characteristic of the first structured packing, the second structured packing and the third structured packing.

7. The apparatus of claim 6, wherein the first specific surface area SA1 is less than 34 ft²/ft³, the second specific surface area SA2 is between 34 ft²/ft³ and 129 ft²/ft³ and the third specific surface area SA3 is above 152 ft²/ft³.

8. The apparatus of claim 7, wherein the first packing segment includes multiple layers of the first structured packing separated by a first layer of the random packing.

9. The apparatus of claim 8, wherein the multiple layers of the first structured packing have a first thickness T1 of 121.92-182.88 cm and the layer of random packing has a thickness T2 of 7.62-15.24 cm.

10. The apparatus of claim 9, wherein the second packing segment includes multiple layers of the second structured packing having the first thickness T1 separated by a second layer of the random packing having the thickness T2.

11. The apparatus of claim 10, wherein the third packing segment includes multiple layers of the third structured packing having the first thickness T1 separated by a third layer of the random packing having the thickness T2.

12. The apparatus of claim 11, wherein the absorber is adapted to remove carbon dioxide from a flue gas stream using a CO₂ absorbent and the apparatus further includes a stripper adapted to remove carbon dioxide from the CO₂ absorbent.

13. The apparatus of claim 12, further including a secondary stripper downstream from the stripper.

14. The apparatus of claim 13, wherein the stripper includes (a) an upper packing section including the third structured packing having the third specific surface area SA3 and (b) a lower packing section including the first or the second structured packing having the first specific surface area SA1 and the second specific area SA2.

15. The apparatus of claim 14, wherein the upper packing section includes multiple layers of the third structured packing separated by a fourth layer of the random packing.

16. The apparatus of claim 15, wherein the lower packing section includes multiple layers of the first or the second structured packing separated by a fifth layer of the random packing.

17. The apparatus of claim 16 wherein the secondary stripper includes (a) a top packing section including the first structured packing having the first specific surface area SA1 and (b) a lower packing section including a fourth structured packing having a fourth specific surface area SA4 where SA4=SA2 or SA3.

18. A method of capturing carbon dioxide from an acid gas stream, comprising:
providing an absorber tower with a first packing segment, having a first specific surface area SA1, a second packing segment, having a second specific surface area SA2, and a third packing segment, having a third specific surface area SA3, where SA1<SA2<SA3;
subjecting the acid gas stream to a countercurrent flow of a carbon dioxide lean CO₂ absorbent in the absorber tower;
separately discharging treated acid gas and a carbon dioxide rich CO₂ absorbent from the absorber tower; and
recovering the carbon dioxide from the carbon dioxide rich CO₂ absorbent in a stripper and returning carbon dioxide lean CO₂ absorbent to the absorber tower.

19. The method of claim 18, including positioning the second packing segment between the first packing segment and the second packing segment.

20. The method of claim 19, including providing at least one in-situ liquid/gas distributor in at least one of the first packing segment, the second packing segment and the third packing segment.
